(19) United States
(12) Patent Application Publication
(10) Pub. No.: US 2013/0029600 A1
(43) Pub. Date: Jan. 31, 2013

(54) WIRELESS COMMUNICATION SYSTEM

(71) Applicant: Hiroki Mochizuki, Shizuoka-ken (JP)

(72) Inventor: Hiroki Mochizuki, Shizuoka-ken (JP)

(73) Assignee: TOSHIBA TEC KABUSHIKI KAISHA, Tokyo (JP)

(21) Appl. No.: 13/555,524

(22) Filed: Jul. 23, 2012

(30) Foreign Application Priority Data
Jul. 28, 2011 (JP) 2011-165896

(51) Int. Cl. H04W 4/00

(52) U.S. Cl. 455/41.2

(57) ABSTRACT

According to one embodiment, a wireless communication system comprises a leaky coaxial cable configured to be vertically arranged on a placing surface, a base station configured to make the leaky coaxial cable radiate electric wave, and an illumination unit configured to illuminate an area coincident with a communication area formed by the electric wave radiated from the leaky coaxial cable arranged on the placing surface.

### CROSS-REFERENCE TO RELATED APPLICATION

This application is based upon and claims the benefit of priority from Japanese Patent Application No. 2011-165896, filed Jul. 28, 2011, the entire contents of which are incorporated herein by reference.

### FIELD

Embodiments described herein relate to a wireless communication system which uses a leaky coaxial cable (LCX) as an antenna.

### BACKGROUND

A wireless communication system using an LCX cable has been popularized in many fields in recent years.

An LCX cable includes a coaxial cable and a plurality of small holes, which are referred to as slots, arranged on the outer conductor part of the coaxial cable. Slots function as a transmitter antenna, thereby enabling the whole cable to serve as an antenna having a radiation direction.

The LCX cable is characterized in that a communication area is formed nearby the cable in the length direction of the cable. By using the characteristic flexibly, a wireless communication system using the LCX cable is a unique system which can realize two conflict elements, i.e., preventing a communication content being overheard from a location away from the LCX cable (security) and allowing an arrangement and a movement freely of a client terminal in a communication area (mobility).

### BRIEF DESCRIPTION OF THE DRAWINGS

FIG. 1 is a schematic diagram roughly showing the structure of the wireless communication system shared in first and second embodiments;

FIG. 2 is a diagram showing an LCX cable of the system;

FIG. 3 is a diagram showing an example of usage of the system;

FIG. 4 is a schematic diagram roughly showing the structure of a wireless communication system according to the first embodiment;

FIG. 5 is an enlarged view of the adjustment mechanism shown in FIG. 4; and

FIG. 6 is a schematic diagram roughly showing the structure of a wireless communication system according to the second embodiment.

### DETAILED DESCRIPTION

According to one embodiment, a wireless communication system comprises a leaky coaxial cable configured to be vertically arranged on a placing surface, a base station configured to make the leaky coaxial cable radiate electric wave, and an illumination unit configured to illuminate an area coincident with a communication area formed by the electric wave radiated from the leaky coaxial cable arranged on the placing surface.

Embodiments are described in detail below with reference to the accompanying drawings.

The components shared in the embodiments are described prior to those distinguishing the embodiments.

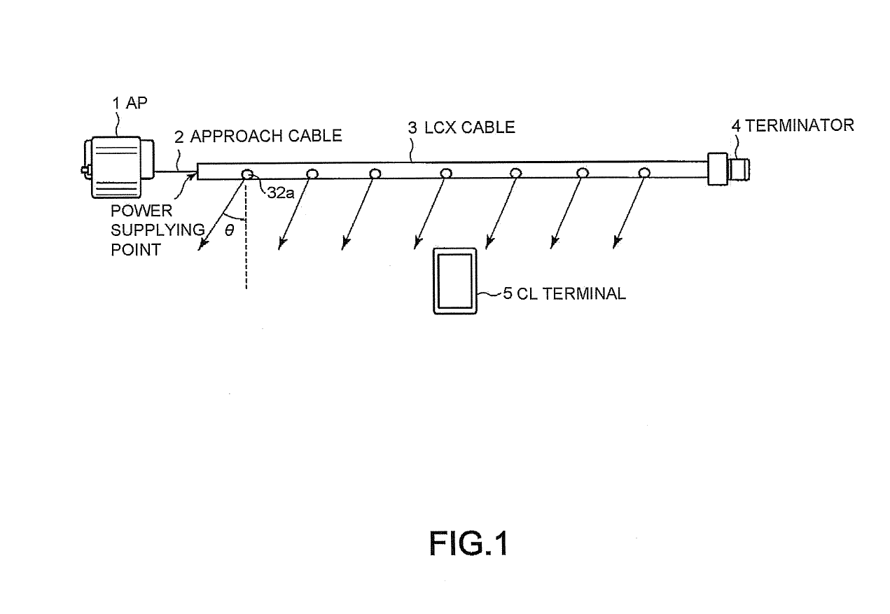

FIG. 1 is a schematic diagram roughly showing the structure of the wireless communication system shared in the embodiments.

The wireless communication system comprises an access point 1 (AP) serving as a base station, an approach cable 2, an LCX cable 3 and a terminator 4. The wireless communication system is responsible for the communication between client terminals 5 such as a laptop PC and a PDA (Personal Digital Assistance) as well as the communication between a client terminal 5 and a device connected with a network such as the Internet.

The access point 1 modulates the transmitting data to generate a high-frequency transmitting signal; amplifies, through a PA (power amplifier), the generated transmitting signal and sends the amplified signal to the LCX cable 3, and demodulates the signal output from the LCX cable to generate receiving data. Moreover, the access point 1 comprises a means for adjusting a transmitting power (transmitting electric power) by changing the target signal amplification value through the PA in response to a command from an external device or the operation of an operation unit arranged at the access point 1.

One end of the approach cable 2 is connected with the access point 1 via a connector (not shown), and the other end thereof is connected with the LCX cable 3 via the connector.

The terminator 4, which is provided to prevent a signal reflection from the end part of the LCX cable 3, is connected, via a connector (not shown), with one end of the LCX cable 3 that is not connected with the approach cable 2.

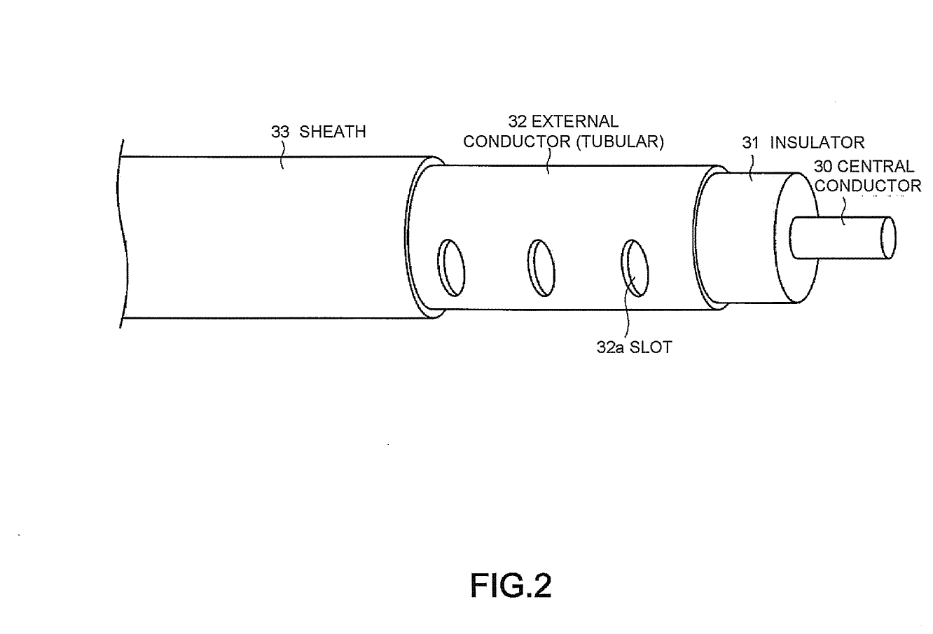

As shown in FIG. 2, the LCX cable 3 comprises: a central conductor 30, which is, for example, a copper cable that is arranged in the center of the LCX cable with a circular section; an insulator 31, which is made from, for example, polyethylene and covers the outer surface of the central conductor 30; an external tubular conductor 32, which is made from, for example, aluminum, and covers the outer surface of the insulator 31; and a sheath 33, which is made from, for example, black polyethylene, and covers the outer surface of the external conductor 32.

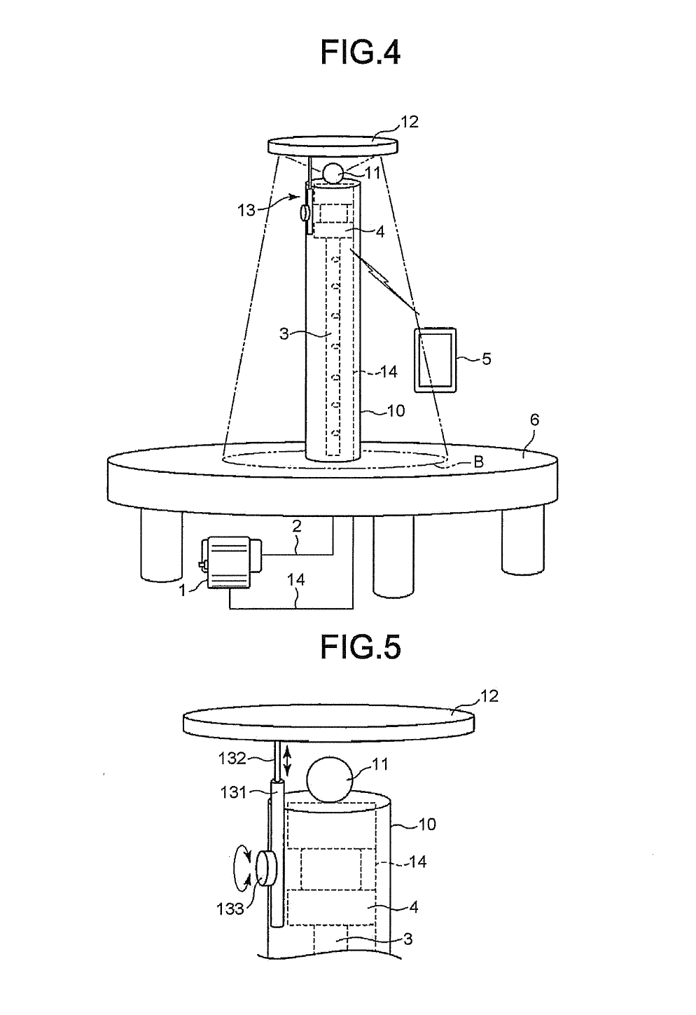

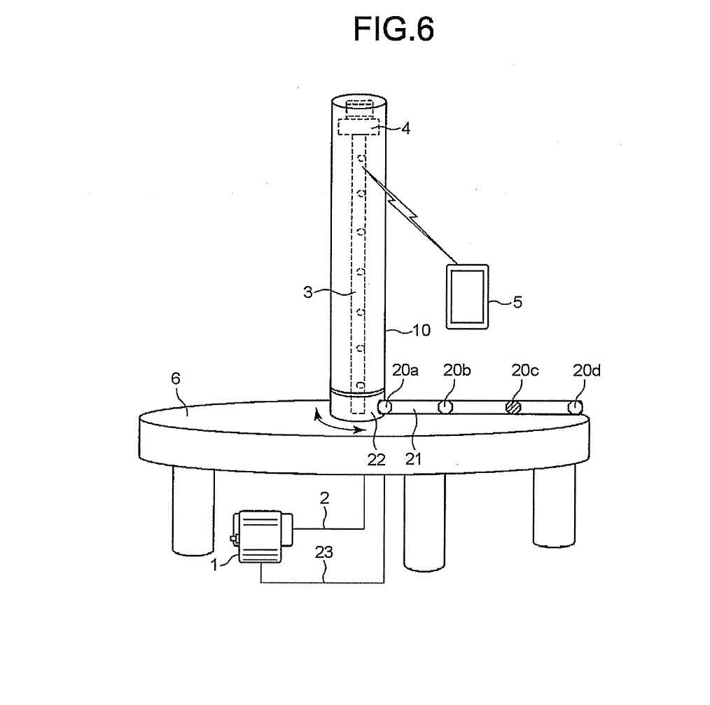

A plurality of slots 32A having a given shape are arranged on the external conductor 32. Moreover, the slots 32A hidden behind the sheath 33 are schematically represented but not all shown in FIG. 1 (The same can be said about FIG. 4 and FIG. 6). Each slot 32A is an opened hole the arrangement interval of which is adjusted corresponding to the length of the electric wave used by the wireless communication system. Each slot 32A serves as an antenna for transmitting electric wave with the client terminal 5. In this way, the whole LCX cable 3 acts like an array antenna to form a communication area along the length direction of the LCX cable 3, wherein the communication area is formed approximately in the same distance from the LCX cable 3 along the length direction thereof.

Moreover, the transmission/reception direction of the electric wave is inclined against the LCX cable 3 by a given degree corresponding to the shape of the slots 32A and the space (interval) between the slots 32A. FIG. 1 exemplarily shows the so-called ‘backfire’, which means that the transmission/reception direction (indicated by the arrow shown in FIG. 1) of the electric wave is inclined towards the connection point (power supplying point) of the approach cable 2 and the LCX cable 3 by an angle θ (0<θ<90.)

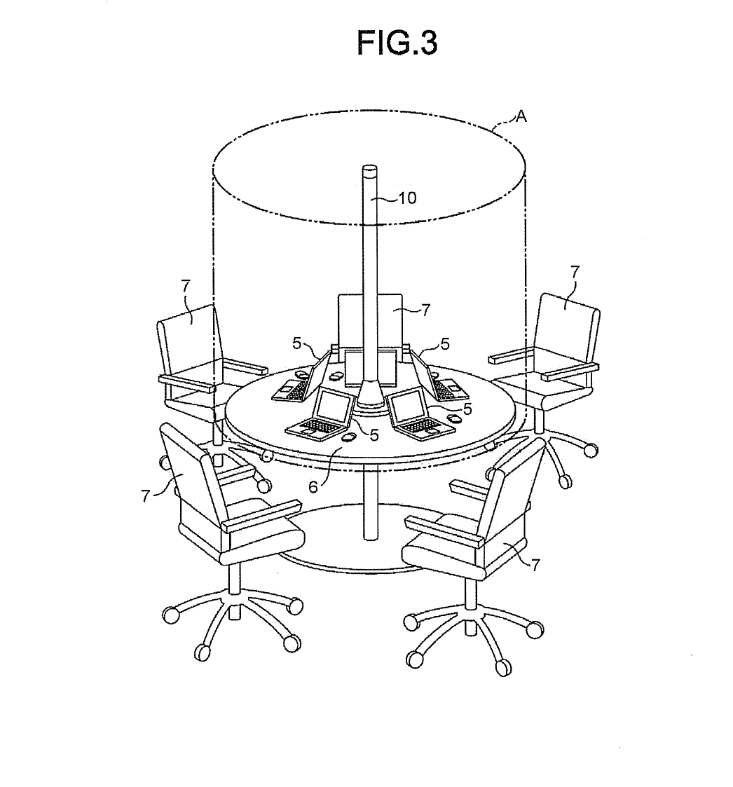

The wireless communication system with the structure above can be vertically mounted on a table in an office or shop, as shown in FIG. 3. An example shown in FIG. 3 shows the following case: a cylindrical sheath component 10 for accommodating the LCX cable 3 is vertically arranged at the center of the placing surface of a round table 6, and a communication area A is adjusted to have a size suitable for covering the whole table 6. When used in this environment, the client terminals 5 such as the laptop PC placed on the table 6 and the tablet PC manually operated by users sitting on the chair 7 can perform a radio-communication with another client terminal 5 via the wireless communication system or connect with the Internet. The sheath component 10 is made from a nonconductive material with low dielectric constant, for example, plastic, causing no interference to the wireless communication between the LCX cable 3 and the client terminal 5.

The wireless communication system can be used in various other forms, but not limited to the form shown in FIG. 3.

Next, the first and second embodiments are described.

In the wireless communication system with the structure above, in order to realize a communication area suitable for a purpose of use, the transmission power of the access point 1 must be adjusted to an appropriate level. As stated above, this adjustment can be carried out in the following way: arranging the client terminal 5 which carries out a communication using the wireless communication system at the position remotest from the LCX cable 3 in a communication area to be constructed, and reducing the transmission power of the access point 1 to the lowest level at which the client terminal 5 can receive the electric wave from the LCX cable 3.

In the first and second embodiments, a structure that provides an indicator for grasping a distance between the user and the LCX cable 3, and a communication area to the user in determining the position of the client terminal 5 during the above-described adjusting operation or in re-confirming the communication area after the adjusting operation is disclosed.

### The First Embodiment

FIG. 4 is a schematic diagram roughly showing the structure of a wireless communication system according to the first embodiment. The components shown in FIG. 4 which are identical to those shown in FIG. 1-FIG. 3 are represented with identical reference numerals.

As shown in FIG. 3, the wireless communication system according to this embodiment comprises: a cylindrical sheath component 10 for accommodating an LCX cable 3 is vertically arranged at the center of the placing surface of a roundtable 6.

The end part of the LCX cable 3 at a side of the table 6 is connected with an approach cable 2 connected with an access point 1, and the other end of the LCX cable 3 is connected with a terminator 4. For instance, by fixing the end part of the LCX cable 3 connected with the approach cable 2 and the terminator 4 on the inner wall of the sheath component 10, the LCX cable 3 is arranged to be substantially vertical to the placing surface of the table 6. A messenger wire or a pulling wire may also be mounted on the sheath 33 of the LCX cable 3 to arrange the LCX cable 3 more linearly. In this way, if the LCX cable 3 is arranged in the sheath component 10, then the LCX cable 3 is arranged vertically with respect to the placing surface of the table 6.

A light-emitting unit 11, which consists of, for example, a plurality of LEDs (Light Emitting Diode), is arranged on the upper part of the sheath component 10. Further, a disc-shaped reflecting plate 12 is arranged above the light-emitting unit 11. The light-emitting unit 11 and the reflecting plate 12 constitute a lighting unit in this embodiment. At least the lower surface (the surface close to the light-emitting unit 11) of the reflecting plate 12 is a mirror-finished surface, and the reflecting plate 12 is mounted on the sheath component 10 through an adjustment mechanism 13, with the lower surface thereof parallel to the placing surface of the table 6.

The light-emitting unit 11 is connected with the access point 1 via a power line 14 that is inserted into the sheath component 10. The access point 1 controls the power supply to the light-emitting unit 11 through the power line 14 to turn on or turn off the light-emitting unit 11.

FIG. 5 is an enlarged view of the adjustment mechanism 13.

The adjustment mechanism 13 comprises a measuring cylinder 131 fixed on the sheath component 10, a transmission shaft 132 fixed on the reflecting plate 12 and a locking instrument 133 for fixing the transmission shaft 132 on the measuring cylinder 131. The transmission shaft 132 firmly inserted into the measuring cylinder 131 can slide in the direction indicated by the arrow shown in FIG. 4 to adjust a distance between the reflecting plate 12 and the light-emitting unit 11.

The locking instrument 133 has external threads, while the measuring cylinder 131 has internal threads running through the inner wall thereof from one side of the measuring cylinder 131. The locking instrument 133 is rotated manually to screw the external threads into the internal threads of the measuring cylinder 131 until the external threads are propped against the transmission shaft 132, thereby fixing the transmission shaft 132 on the measuring cylinder 131.

After turned on, the light-emitting unit 11 emits light, which is then reflected by the reflecting plate 12 to illuminate a circular area on the placing surface of the table 6 that is concentric with the vertically arranging axis of the LCX cable 3 as its center. The character B shown in FIG. 4 indicates an illumination range by the reflected light.

If the light-emitting unit 11 is placed further from the reflecting plate 12, the illumination range B is broadened from the vertically arranging axis of the LCX cable 3 as its center, and if the light-emitting unit 11 is placed closer to the reflecting plate 12, the illumination range B is narrowed toward the vertically arranging axis of the LCX cable 3 as its center.

In this embodiment, a distance between the light-emitting unit 11 and the reflecting plate 12 is adjusted by the adjustment mechanism 13 in such a manner that the illumination range B coincides with the communication area formed around the LCX cable 3.

This adjustment is carried out in the following way: for instance, the distance between the light-emitting unit 11 and the reflecting plate 12 is kept to be an optional value, the client terminal 5 is arranged at the position remotest from the LCX cable 3 in the illumination range B, then the transmission power of the access point 1 is reduced until the transmission power becomes the lowest one at which the client terminal 5 can still communicate with the access point 1.

Alternatively, the client terminal 5 is arranged at any position of the placing surface of the table 6 first, and then the transmission power of the access point 1 is reduced until the transmission power becomes the lowest one at which the client terminal 5 can still communicate with the access point 1, and the illumination range B is adjusted by the adjustment mechanism 13 in such a manner that the client terminal 5 is located at a position remotest from the LCX cable 3 in the illumination range B.

In this way, if the communication area of the wireless communication system corresponding to the illumination range B is illuminated, an indicator for identifying a communicable area can be provided to users who place the client terminal 5 such as laptop PC and tablet PC on the table 6 and carry out a communication using the wireless communication system.

Moreover, owing to the arrangement of the adjustment mechanism 13, the illumination range B can be adjusted corresponding to a change in the communication area.

### The Second Embodiment

FIG. 6 is a schematic diagram roughly showing the structure of the wireless communication system according to the second embodiment. The components shown in FIG. 6 identical to those shown in FIG. 1-FIG. 5 are represented with identical reference numerals.

In this embodiment, the light-emitting unit 11, the reflecting plate 12, the adjustment mechanism 13 and the sheath component 10 are not arranged, but a plurality of light-emitting units 20A, 20B, 20C and 20D are arranged instead in a direction perpendicular to the vertically arranging axis of the LCX cable 3, that is, the direction parallel to the placing surface of the table 6.

More specifically, the light-emitting units 20A, 20B, 20C and 20D are mounted, at given intervals, on an elongated rod-shaped component 21 extending in the direction perpendicular to the vertically arranging axis of the LCX cable 3. One end of the rod-shaped component 21 is attached to a rotation component 22 that is arranged below the lower end of the sheath component 10 in a freely rotatable manner. The rotation component 22, which is made from the same material as the sheath component 10, that is, a nonconductive material with low dielectric constant, is formed into a hollow shape for the insertion of the sheath component 10.

The light-emitting units 20A-20D, which are, for example, LEDs, are connected with the access point 1 via the power line 23 that runs through the sheath component 10, the rotation component 22 and the rod-shaped component 21. The access point 1 controls the power supply to the light-emitting units 20A-20D through the power line 23 to selectively turn on or turn off the light-emitting units 20A-20D.

In this embodiment, the access point 1 controls the light-emitting units 20A-20D to emit light to indicate the communication area formed by the electric wave radiated by the LCX cable 3.

Specifically, for instance, if the access point 1 is instructed to turn on an optional one of the light-emitting units 20A-20D, the client terminal 5 is arranged nearby the turned-on light-emitting unit, then the transmission power of the access point 1 is reduced to the lowest level at which the client terminal 5 can still communicate with the access point 1.

Alternatively, the client terminal 5 is arranged at any position on the placing surface of the table 6 along the rod-shaped component 21 beforehand, the transmission power of the access point 1 is reduced to the lowest level at which the client terminal 5 can still communicate with the access point 1, then the access point 1 is instructed to turn on the one of the light-emitting units 20A-20D that is closest to the client terminal 5.

After the operations above are carried out, the turned-on one of the light-emitting units 20A-20D coincides with the end part (the part remotest to the LCX cable 3) of the communication area, thus, it can be recognized visually that an area from the turned-on light-emitting unit toward the LCX cable 3 is the communication area.

Further, the light-emitting units closer to the LCX cable 3 than the one turned on in this way may be all turned on.

Further, the instruction to the access point 1 may be input by operating the operation unit arranged on the access point 1, or input from the client terminal 5 through a wireless communication carried out using the LCX cable 3.

Like in the first embodiment, in the case where the communication area of the wireless communication system is represented with the light-emitting units 20A-20D, an indicator for identifying a communication area can be provided to the user who places the client terminal 5 such as laptop PC and tablet PC on the table 6 to carry out a communication using the wireless communication system.

Further, the access point 1 may be instructed to change one of the light-emitting units 20A-20D that is turned on corresponding to a change in the communication area.

Moreover, since the rod-shaped component 21 is rotationally arranged on the sheath component 10 via the rotation component 22, the communication area can be displayed at any position on the placing surface of the table 6.

[Modification]

The apparatus disclosed in each embodiment may be embodied by appropriately modifying the structural components when in implementation.

For instance, in the first embodiment, it is exemplarily illustrated that the illumination range B is adjusted by changing the distance between the light-emitting unit 11 and the reflecting plate 12. However, the illumination range B may also be adjusted by changing the angle of the reflecting plate 12 or the brightness of the light-emitting unit 11.

Moreover, in the second embodiment, it is exemplarily shown theta communication area is indicated with four light-emitting units 20A-20D; however, the communication area may also be indicated with light-emitting units more or less than the above. Further, the light-emitting units may be embedded into the placing surface of the table 6 and selectively turned on to indicate a communication area.

Moreover, in the first embodiment, the illumination range B coincident with the communication area may be set automatically. In this case, the adjustment mechanism 13 may move the reflecting plate 12 up and down through the rotation of a motor or a hydraulic pressure, and a table that specifies the relationship between a distance from the default position to a lifted position of the reflecting plate 12 and a transmission power is pre-stored in the memory of the access point 1. The relationship specified in this table can be grasped by, for example, measuring, through experimentation, lifted distances at which communication areas corresponding to transmission powers coincide with illumination ranges B respectively as the transmission power of the access point 1 is changed.

Moreover, when changing the transmission power of the access point 1, the control unit of the access point 1 specifies the lifted distance corresponding to the changed transmission power based on the table, and the adjustment mechanism 13 is driven so that the reflecting plate 12 is located at the specified lifted distance.

Moreover, in the second embodiment, each of the light-emitting units 20A-20D may be turned on automatically to indicate a communication area. In this case, a table that specifies the relationship between one of the light-emitting units 20A-20D closest to the end part (the part remotest to the LCX cable 3) of the communication area and a transmission power is pre-stored in the memory of the access point 1. The relationship specified in this table can be grasped by, for example, specifying, through experimentation, a light-emitting unit closest to the end part of the communication area corresponding to each transmission power as the transmission power of the access point 1 is changed. Moreover, when the transmission power of the access point 1 is changed, the control unit of the access point 1 specifies the light-emitting unit corresponding to the changed transmission power based on the table and turns on the specified light-emitting unit or all the light-emitting units that are closer to the LCX cable 3 than the specified light-emitting unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication system, comprising:
a leaky coaxial cable configured to be vertically arranged on a placing surface;
a base station configured to make the leaky coaxial cable radiate electric wave; and
an illumination unit configured to illuminate an area substantially coincident with a communication area formed by the electric wave radiated from the leaky coaxial cable arranged on the placing surface.

2. The system according to claim 1, further comprising:
an adjustment unit configured to adjust the illumination area by the illumination unit on the placing surface.

3. The system according to claim 1, wherein
the illumination unit comprises:
a light-emitting unit configured to emit the light; and
a reflecting plate configured to reflect the light emitted by the light-emitting unit and illuminate an area on the placing surface with the reflected light

4. A wireless communication system, comprising:
a leaky coaxial cable that is vertically arranged on a placing surface;
a base station configured to make the leaky coaxial cable radiate electric wave;
a plurality of light-emitting units that are arranged in a direction substantially perpendicular to the vertically arranging axis of the leaky coaxial cable; and
a control unit configured to control the light-emitting units to emit light so as to indicate the communication area formed by the electric wave radiated from the leaky coaxial cable.

5. The system according to claim 4, wherein
the control unit controls the light-emitting unit arranged at the end part of the communication area or the light-emitting units positioned within the communication area to emit light therefrom.

6. The system according to claim 4, further comprising:
a lengthwise member that extends in a direction perpendicular to the vertically arranging axis of the leaky coaxial cable and is rotationally arranged as the vertically arranging axis being a rotation axis; wherein the light-emitting units are arranged on the lengthwise member at given intervals.

7. The system according to claim 6 further comprising a cylindrical sheath component in which the leaky coaxial cable is housed.

8. The system according to claim 7 wherein the cylindrical sheath component includes a rotation member to which the lengthwise member is attached to be rotated with the rotation member.
